(19) United States
(12) Patent Application Publication
(10) Pub. No.: US 2010/0283706 A1
(43) Pub. Date: Nov. 11, 2010

(54) HOUSING WITH BUILT-IN ANTENNA AND METHOD FOR FABRICATING THE SAME

(75) Inventors: BEN-DING TSAO, Shindian (TW); BING-YA WANG, Shenzhen City (CN); JUN XIONG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/634,789

(22) Filed: Dec. 10, 2009

(30) Foreign Application Priority Data
May 11, 2009 (CN) 200910302221.3

(51) Int. Cl. H01Q 1/42; B29C 45/14

(52) U.S. Cl. 343/872; 264/272.11

(57) ABSTRACT

A housing functioning as an antenna includes: a decorative film, an antenna member having a connecting pole, and a base body. The housing is formed by injection molding a molten plastic material over the decorative film, the base body is formed from the molten plastic material, and the antenna member is embedded between the decorative film and the base body, the connecting pole is exposed to the outside. A method for fabricating the housing is also described.

### CROSS-REFERENCE TO RELATED APPLICATION

This application is related to co-pending U.S. Patent Application (Attorney Docket No. US26863, entitled “HOUSING WITH BUILT-IN ANTENNA AND METHOD FOR FABRICATING THE SAME”, by BEN-DING TSAO et al., which is the same assignee as the present application. The above-identified application is incorporated herein by reference.

### BACKGROUND

1. Technical Field

The present disclosure relates to a housing with a built-in antenna, and a method for fabricating the housing.

2. Description of related art

Portable electronic devices generally use antennas for receiving and/or sending signals. The antenna is usually assembled inside the portable electronic device by adhering or hot melting the antenna to a circuit board, which increases costs. Additionally, it can be difficult to arrange the antenna and many other electronic components inside the portable electronic device, if it is desired that the portable electronic device be smaller and more portable.

Therefore, there is room for improvement within the art.

### BRIEF DESCRIPTION OF THE DRAWINGS

Many aspects of the new housing with built-in antenna, and method for fabricating the housing can be better understood with reference to the following drawings. The components in the drawings are not necessarily drawn to scale, the emphasis instead being placed upon clearly illustrating the principles of the exemplary embodiment. Moreover, in the drawings, like reference numerals designate corresponding parts throughout the several views.

FIG. 1 is an isometric view of a housing with built-in antenna according to an exemplary embodiment.

FIG. 2 is an exploded isometric view of the housing shown in FIG. 1.

FIG. 3 is a partial cross-section isometric view of the decorative film of the housing shown in FIG. 2.

FIG. 4 is a schematic view of fabricating the housing shown in FIG. 2.

### DETAILED DESCRIPTION OF THE EMBODIMENT

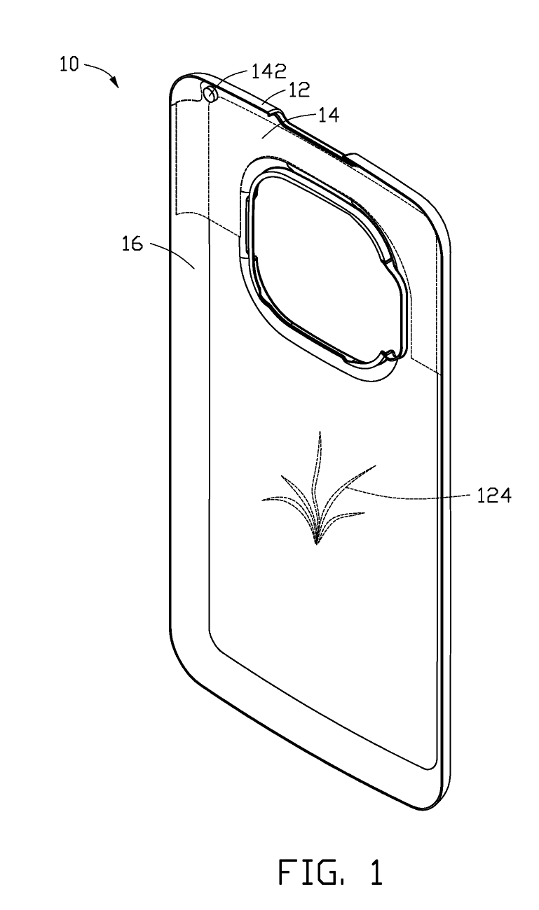

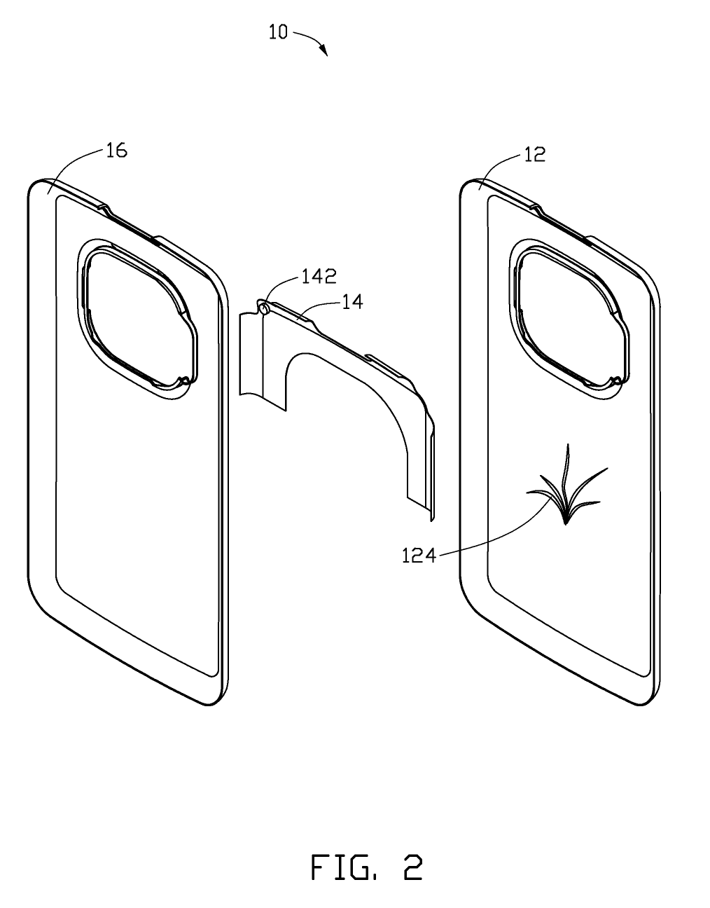

FIGS. 1 and 2 show an exemplary housing 10 with built-in antenna for portable electronic devices, such as mobile phones, etc.

The housing 10 includes a decorative film 12, an antenna member 14, and a base body 16. The decorative film 12 functions as the exterior surface layer of the housing 10. The antenna member 14 is embedded between the decorative film 12 and the base body 16.

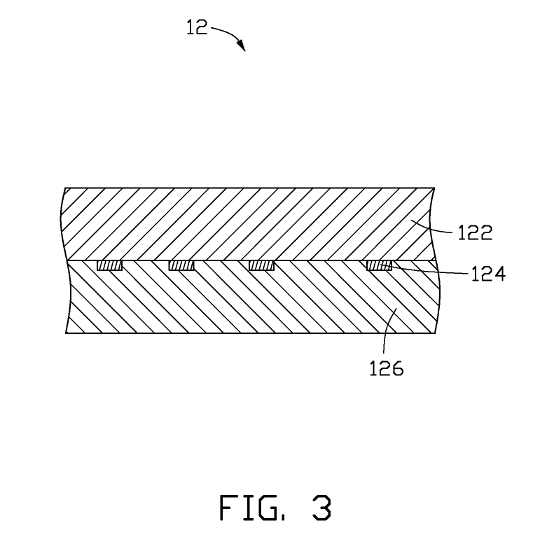

Referring to FIG. 3, the decorative film 12 includes a base layer 122, a pattern layer 124, and an adhesive layer 126. The base layer 122 is transparent and can be made of a thermoplastic macromolecular material such as polycarbonate, polyethylene terephthalate, or a combination thereof. The pattern layer 124 is comprised of various kinds of inks and can be printed on a surface of the base layer 122 to decorate the base layer 122. The adhesive layer 126 is printed on the base layer 122 and covers the pattern layer 124. The adhesive layer 126 is made of a thermo-sensitive resin or a pressure-sensitive resin and thus has good adherence. The adhesive layer 126 is used to firmly adhere the base layer 122 and the base body 16.

The antenna member 14 can be made from a metal sheet such as a copper sheet. The antenna member 14 can alternatively be formed by printing electro-inks on a plastic plate. The antenna member 14 has a connecting pole 142 protruding from the corner thereof. The connecting pole 142 is conductive and electronically connects the antenna member 14 to inner circuitry of an electronic device.

The base body 16 may be made of any one or more of plastic materials such as PE (polyethylene), PA (polyamide), PC (polycarbonate), ABS (acrylonitrile butadiene styrene), PMMA (polymethyl methacrylate) and PET (polyethylene terephthalate).

A method of making the housing 10 may include at least the following steps.

Provide a planar base layer 122. Print a pattern layer 124 on a surface of the base layer 122. The printing is performed using any suitable method known in the art. An adhesive layer 126 is printed on the surface having the pattern layer 124. In this case, the adhesive layer 126 covers the pattern layer 124. At this point the decorative film 12 is fabricated.

The decorative film 12 is then hot-pressed and cut to achieve a three-dimensional preformed decorative film 12.

An antenna member 14 is placed on and adheres to the adhesive layer 126 of the decorative film 12.

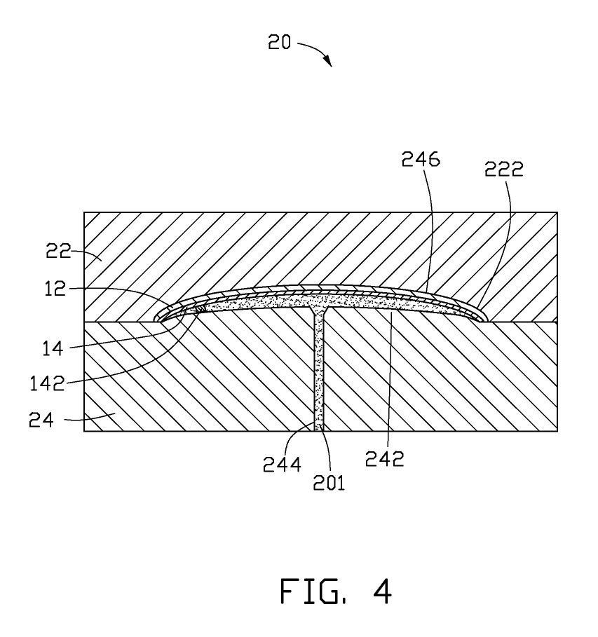

Referring to FIG. 4, a mold 20 is provided including a female plate 22 and a male plate 24 engagable with the female plate 22 is provided. The female plate 22 defines a cavity 222, and the male plate 24 forms a core 242 to engage with the cavity 222. The male plate 24 defines a channel 244 through the core 242 to guide a molten plastic material into the cavity 222. The preformed decorative film 12 is placed into the cavity 222. The base layer 122 of the decorative film 12 abuts the bottom of the cavity 222. The mold 20 is closed, the male plate 24 engages with the female plate 22, and the core 242 is received into the cavity 222 and accordingly encloses/defines a chamber 246. A molten plastic material 201 is injected into the chamber 246. The molten plastic material 201 passes through the channel 244 into the chamber 246. The molten plastic material 201 combines with the adhesive layer 126 of the decorative film 12. The molten plastic material 201 cools to form the base body 16. At this time, the antenna member 14 is embedded between the decorative film 12 and the base body 16, the connecting pole 142 of the antenna member 14 is exposed to outside through the base body 16. The housing 10 is thus formed.

When the housing 10 is applied to an electronic device (not shown), the connecting pole 142 of the antenna member 14 electrically contacts the circuit of the electronic device, receiving and/or sending signals.

As described above, the housing 10 with built-in antenna is formed by injection molding a molten plastic over the decorative film 12. The antenna member 14 is embedded in the housing 10, the connecting pole 142 of the antenna member 14 is exposed out of the housing 10 to electronically connect to a circuit of an electronic device. The pattern layer 124 of the decorative film 12 makes the housing 10 aesthetically pleasing; and the base layer 122 is wear-resistant and protects the housing 10.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A housing having an antenna, comprising:
a decorative film;
an antenna member having a connecting pole; and
a plastic base body, the plastic base body attached to the decorative film;
the antenna member embedded between the decorative film and the base body, with the connecting pole exposed to the outside.

2. The housing as claimed in claim 1, wherein the decorative film includes a base layer, a pattern layer, and an adhesive layer, the base layer is transparent, the pattern layer is printed on the base layer and located between the base layer and the pattern layer.

3. The housing as claimed in claim 2, wherein the base layer is made of thermoplastic macromolecular material such as polycarbonate, polyethylene terephthalate or a combination thereof.

4. The housing as claimed in claim 1, wherein the antenna member is made of a sheet metal.

5. The housing as claimed in claim 4, wherein the antenna member is made of a copper sheet.

6. The housing as claimed in claim 4, wherein the base body is made of plastic materials such as PE, PA, PC, ABS, PMMA and PET, one or any combination thereof.

7. A method for fabricating a housing having an antenna, comprising:
placing a decorative film into a mold, injecting a molten plastic material into the mold, the molten plastic material combining with the decorative film to form a base body after cooling, embedding am antenna member between the decorative film and the base body, and exposing the connecting pole to the outside.

8. The method as claimed in claim 7, further comprising a step of fabricating the decorative film, comprising:
providing a planar base layer,
printing a pattern layer on a surface of the base layer,
printing an adhesive layer substantially on the surface of base layer having the pattern layer printed thereon, the adhesive layer covering the pattern layer.

9. The method as claimed in claim 7, wherein before placing the decorative film into the mold, the decorative film is hot pressed and cut to form a preformed decorative film.

10. The method as claimed in claim 7, wherein, the mold includes a female plate and a male plate engagable with the female plate, the female plate defines a cavity, the male plate forms a core to engage with the cavity.
